(19) United States
(12) Patent Application Publication
(10) Pub. No.: US 2024/0272046 A1
(43) Pub. Date: Aug. 15, 2024

(54) TISSUE CHAMBER

(71) Applicant: APPLIKATE TECHNOLOGIES, INC., Washington, DC (US)

(72) Inventors: Michael Levene, Washington, DC (US); Richard Torres, Washington, DC (US)

(21) Appl. No.: 18/347,377

(22) Filed: Jul. 5, 2023

Related U.S. Application Data
(60) Provisional application No. 63/484,908, filed on Feb. 14, 2023.

(51) Int. Cl. G01N 1/36; G01N 1/31

(52) U.S. Cl. CPC G01N 1/36; G01N 1/312

(57) ABSTRACT

The present invention relates to systems and methods for tissue processing and analysis. Tissue chambers are configured to allow single-container chemical processing, imaging, and wax embedding of tissue samples in a single container without manipulation between steps. Tissue chambers with features to support the tissue sample and allow fluid flow between the tissue sample and the tissue chamber surface are disclosed. The features may be index matched to sample structures of interest or dissolvable in clearing solution to allow for in-chamber imaging with minimal distortion.

### FIELD OF THE INVENTION

The present disclosure relates generally to histological systems and methods for simplified positioning, chemical processing, and/or imaging of tissue samples including imaging, staining, fixing, dehydrating, and embedding in a single chamber.

### BACKGROUND

Histology and histopathology involve the study of cells and tissues under a microscope to diagnose and monitor diseases, such as cancer. Many of the fundamental techniques involved in histological analysis are a century or more old and require trained medical professionals.

For standard histological methods, current steps include placing a tissue sample inside a plastic cassette with perforated walls that allow fluid access and exposing the cassette to a fluid environment that changes composition over time to provide chemical fixation of the tissue.

The tissue is eventually dehydrated and permeated with paraffin before removing the embedded specimen from the cassette through melting of the paraffin. After the paraffin permeation and re-melting, the specimen is re-positioned in molten paraffin and allowed to cool again to fix the specimen in an orientation that permits sectioning slices of the specimen in a plane of choice, optimized for clinical interpretation. The slices are then placed on a slide, stained, affixed to a coverslip and then either viewed directly by a pathologist or presented to an imager for digitization.

The above approach requires manipulation of tissue during processing, incurring labor costs and significant processing time. Furthermore, small specimens including small skin biopsies and biopsies from the gastrointestinal tract, or long, thin core biopsies where orientation is critical for interpretative review of layers or for complete cross-sections may rotate and bend freely while the cassette is submerged in fluid and exposed to agitation or flow. Those specimens can therefore require significant manipulation and processing time for optimal histological analysis.

Additionally, the full suite of processing steps described above must be completed before a pathologist can begin substantive analysis of the specimen thereby incurring labor costs and delaying diagnoses.

In considering how to alleviate these technical and manual challenges of tissue preparation, modifications that allow imaging tissue directly without physical sectioning is possible and highly desirable. Maximal advantage of this approach for minimizing time, labor, and cost of processing is achieved if it is possible to utilize a low-cost single tissue holder/cassette for both processing and imaging. However, there are several key considerations. One is that there are multiple fluids involved in processing which must be exchanged in timed sequence. Another is that imaging typically requires a specimen lie flat against a sealed surface which would reduce access of chemicals during incubation. A third issue, especially significant to imaging samples within an imaging fluid, is managing potential air or gas bubbles within this imaging cassette. It is critical to minimize gaseous bubbles during incubations, particularly since some reagents are costly (e.g. dyes) so constant addition of reagents, which might obviate the problems created by bubbles, is undesirable, but also because gas bubbles reduce contact area for diffusion of reagents and the bubbles distort imaging to a high degree. As such, filling a tissue chamber with these reagents requires special effort be made to avoid or disperse bubbles. These and other practical considerations create considerable design challenges.

### SUMMARY

The present invention provides a single chamber solution for sample processing (e.g., dehydration, fixation, staining, and embedding) thereby reducing costs, labor, and time required for histological analysis. Furthermore, the present invention allows for the efficient incorporation of intermediary imaging steps during tissue processing thereby offering benefits such as earlier access to diagnostic information and the potential to avoid the costly steps of manual cutting, staining, and slide distribution where the need for such activities can be ruled out based on initial imaging results.

Single-chamber solutions provided herein allow a user to initially orient a sample within the chamber in a desired position for imaging and/or sectioning and then perform all sample processing including fixation and/or dehydration, initial dyeing, imaging, and, optionally, paraffin-embedding, without having to touch or otherwise manually transfer the sample again, reducing errors, reducing manufacturing costs, and reducing processing labor requirements. Accordingly, tissue chambers of the invention allow for automatic sample processing using various processing devices described herein. Container aspects such as specific geometries, materials, and other configurations, allow for the sample to be successfully processed (e.g., dehydrated, fixed, stained, cleared, and, optionally, embedded in solid media) without the need for direct manipulation of the sample. In some embodiments, features on the container surface can aid in fluid access, exchange, and/or flow to all sides of the sample. Sealable ports, such as “self-sealing” and “self-healing” syringe injection ports, of which there are needle and need-less varieties, permit fluid exposure, motion, and exchange while preventing potential gas-bubble formation and trapping that could affect imaging. A key aspect is that the chamber that is created is air-tight, so as to prevent highly volatile agents which are part of processing (e.g. alcohols) from evaporating rapidly during incubation as this would both uncontrollably change the dye concentration in residual fluid and risk drying completely the specimen which results in irreversible morphologic changes. It is also of practical importance to design the chamber with a durable seal that enables long-term storage of a sample in either liquid, wax (e.g. paraffin), or polymer embedding material.

Our initial attempts at resolving the bubble issues centered upon ensuring that no air was introduced into the chamber during fluid filling. This approach worked reasonably well in the context of chamber dimensions small enough so that capillary action maintains fluid attached to all cross-sectional chamber channel sides and air does not have a risk of getting trapped. In a horizontally aligned tubular chamber these conditions relate to the degree of intermolecular attractive forces of the fluid relative to gravitational forces, as described by the dimensionless ratio known as the Bond number. The relevant parameters are the density of the fluid, the surface tension of the fluid (and tissue), and the dimensions of the fluid chamber. For water in a glass tube, the fluid will remain attached with characteristic dimensions of about 2 mm. Beyond that, there is increased risk that fluid will become detached from the chamber walls and possibly a portion will reach the outlet while air is within the chamber, after which fluid continues flowing around a trapped gas bubble and it becomes difficult to expel. Critically, we have observed that tissue incubated with methanol mixtures at temperatures in the range of 40-50 degrees celsius result in the evolution of gas bubbles which similarly affect fluid exchange in dehydration, dyeing, and organic solvent steps of processing, and creating additional challenges in reducing the detrimental effects of bubbles.

Port location and chamber orientation are relevant to reducing bubble effects. By positioning the outlet port higher than the inlet port and at or near the highest point of the interior of the chamber during filling, gas can escape during the filling process. Any air/gas within the chamber will rise toward the elevated outlet port and be purged as fluid fills the chamber. One approach we have demonstrated to increase dye access to large imaging surfaces is using either index matched or solvent-susceptible features between the imaging window and the sample to allow for fluid exposure at the imaging surface during processing. These features may be either transparent during imaging or dissolved prior to imaging, substantially reducing or eliminating optical distortion during imaging. We have also shown that inclusion of a substantially non-fluorescent and non-reflective sponge between the specimen and the non-imaging surface of the chamber can aid in mounting and/or positioning, help ensure position is maintained, prevent artifacts of tissue compression, allow fluid flow around the non-imaging sides of the specimen that can speed up overall fluid exchange, and provide a surface for improved ‘wetting’. When optically transmissive, it can also allow imaging through more than one surface, of particular value for use of the multiphoton modality known as second harmonic generation which can be detected in both transmission or reflection, but is best detected in transmission.

Alternatives have been explored for fixing the position of small specimens during tissue processing so that re-positioning at the wax-embedding step is not necessary such as the techniques described in U.S. Pat. No. 8,796,038 and US 20080227144, incorporated herein by reference. However, none of those prior methods allow for imaging directly after the clearing step—they all are designed for eventual removal by manual cutting and staining prior to visual interpretation or digital scanning. Additionally, these will typically not work for orienting many common types of biopsies including gastrointestinal or skin biopsy specimens which are best imaged in a very specific orientation and have irregular geometries.

The present invention provides a significant advantage over existing techniques by allowing a specimen to be placed in a container for histologic analysis before complete chemical processing (i.e. either before or after exposure to formalin fixative) and to undergo chemical processing to the clearing stage in the oriented position in a single container device that can be used for all the steps of dehydration, staining, clearing, and imaging. Furthermore, tissue chambers of the invention can then optionally be used for paraffin- or polymer-embedding and optionally for subsequent automated or machine-assisted removal of the embedded sample using a removal device configured to work with tissue chambers of the invention.

As noted above, tissue chambers can include features operable to minimize the contact area between the floor and/or walls of the chamber and the sample, thereby permitting good fluid access to all areas of the sample for fixatives, stains, dehydration solutions, molten embedding materials, and/or other processing fluids. The walls of the chamber as well as the features can be optically clear and/or refractive index matched to the clearing solution and/or the structures of the sample to be examined (e.g., organelles, membranes, or proteins). The features may comprise irregular surfaces which effectively function as microchannels, with dimensions in the range of tens of micrometers to 500 micrometers. In some embodiments the surface irregularities form channels with 100 micrometers in height. In other embodiments the channels are 200 micrometers in depth. In other embodiments the channels are 50 micrometers in depth. In still other embodiments the surface features are bumps of similar dimensions. In certain embodiments, the features may comprise a material that dissolves in the presence of certain solutions used in sample processing (e.g., a clearing solution) such that the features space the sample from the vessel walls and provide good fluid contact to all portions of the sample for processing but have dissolved before any initial imaging of the sample within the chamber and therefore do not disrupt the imaging process. The walls of the tissue chamber itself (or imaging window portions therein) are substantially optically clear and/or index matched to the clearing solution and/or the structures of the sample to be examined in preferred embodiments. In some embodiments, the index is exactly or close to that of common coverslips, typically made of glass with refractive index of about 1.515 at specific visible wavelengths.

Single-chamber processing as described herein can provide the additional advantage of minimizing reagent use. Processing of the sample within the chamber allows for tight control over the volume of the chamber and the reagents used in processing. Instead of placing a cassette containing tissue that is open to a fluid environment that may be hundreds of times the volume of the tissue as in prior techniques, a single sample processing vessel as described herein can have volume that is minimized relative the target size of tissue, reducing expenditure on reagents. The optimal ratio of fluid to tissue can vary depending on the desired compromise between speed of processing and depth of imaging. As a general rule, the reagent volume should be at least 11 times the volume of the tissue volume, but imaging to a few hundred microns of depth requires a lower ratio than this. Reagent conservation is particularly important for controlling dye costs, which could otherwise be prohibitive, particularly for certain fluorescent markers. Hence, a sample-tailored reagent vessel is particularly suited for processing that incorporates dyeing of un-embedded specimens, and especially fluorescent dyeing where the cost of the dye may be a dominant or significant cost-component.

The single chamber techniques described herein also reduce processing times over existing methods. With current methods, it is more economical to wait until sufficient samples have been received and “grossed” (placed into cassettes) before loading a tissue processor. The single chamber approach can be combined with a specialized tissue processor operable to receive tissue chambers of the present disclosure through, for example, interfacing with fluid inlets/outlets of the chamber. Once a chamber is loaded with a specimen, the specimen can be plugged in and processed immediately; reducing the time the specimen must sit idle waiting for additional samples as in multiplex processing. The same applies to the steps subsequent to embedding including slide collation, slide staining, and organization and scanning of slides for digitization. As noted above, single chamber systems described herein allow for varying geometries to more tightly correspond to individual sample geometry, reducing chamber fluid volume and reagent consumption. Chambers within the tissue cassette can be designed so that the sample is matched to the minimum-size vessel accommodating the specimen. For example, a long core biopsy can be placed in a long thin channel.

Vessels can be coded (e.g., with a machine-readable symbol such as a matrix barcode (QR) or UPC code, or any symbol of recognizable shape, color, or reflective pattern). This can be a universally unique identifier (UUID) that uniquely identifies a cassette prior to addition of a sample to allow a tissue processor to automatically recognize the geometry of the tissue chamber being used and to adjust input volumes accordingly, thereby further minimizing wasted reagents. In various embodiments, the vessel itself may be color coded to indicate geometry, which can be recognized by the processing machine to determine adequate fluid quantity and incubation times for the specific sample, resulting in considerable savings in reagent costs, reduction in waste, and consistent processing results while minimizing average processing times. In some embodiments the identifier includes information that can help track manufacturing or user details such as client, date, and location. The unique identifier can be linked by a user to a specimen through a laboratory and/or hospital information system (LIS/HIS), thereby creating a means by which the data can be associated with a source subject. In some embodiments the cassette incorporates an area to allow a second label to be printed or affixed, in case an institution desires to further identify the sample/cassette by visual means or any of the various known methods for machine reading of a label. For example, this would allow a user to read a local specimen number or a patient name, and also satisfy requirements for identification established by laboratory accrediting agencies.

Similarly, microscope scanning and imaging time can also be reduced with sample-specific sized chambers. While microscope slide scanners use various approaches to minimize slide scanning time, they are still inefficient and manually dependent to varying extents. Current systems typically take a low power image and use image processing algorithms to estimate the position and size of the tissue, but they are adversely affected by difficult-to-control artifacts such as mounting variability, dirt, and smudges. As a result, manual supervision may be required to ensure tissue is not missed and that large empty spaces are not imaged. Operator adjustment of scanning area is a time-consuming component of slide scanning which can result in repeat scans and high average slide scan times.

Coded, sample-size specific chambers as described herein can help avoid manual interventions while maximizing efficiency for image scanning. Because a tissue is placed in the smallest chamber in which it fits and the imager is able to read the chamber coding to determine the size of the region to scan, the entire possible tissue location region may be imaged without excessive time wasted imaging regions without tissue. The chance for error can be reduced and operator intervention should not be required, providing efficient imaging with reduced labor costs and errors.

Tissue holders in this invention include a trough area or cavity cutaway sized to contain a sample and various processing fluids wherein processing of the sample occurs. The trough is in fluid communication with one or more fluid inlets or outlets operable to provide processing fluids to the tissue-containing chamber. The tissue holder may comprise additional material surrounding the trough to allow for ease of manipulation and/or orientation of the chamber within various processing apparatuses. In preferred embodiments the internal cavity is formed by two components. A first component is bounded on one side by an imaging window which is optically matched in thickness and refractive index to the requirements of the design of the imaging microscope objective. In preferred embodiments, this refractive index is between 1.5-1.7 and the thickness is less than 600 microns. In further preferred embodiments this refractive index is between 1.5-1.6 and the thickness is 500 microns or less. In certain embodiments the thickness is 150 micrometers or less. In some optimized versions, the thickness is 100 micrometers or less. In some embodiments, the window has a refractive index equal or similar to that of glass commonly used in coverslips, or about 1.515. In some embodiments, the window is made from coverslip glass. In discussing specific refractive index values, it is understood that standard wavelengths for measurement exist and that the value may vary with the wavelength that is used for measurement. The most directly relevant refractive index in this context is at the wavelength of excitation so that the window contribute as little as possible to deviation of light. In that regard, if the window is thin, it may deviate more in refractive index, within limits dependent on the lenses used, from that of the immersion fluid. In other preferred embodiments the refractive index is matched to the microscope immersion fluid such that the quality of image formation by the microscope objective is largely independent of window thickness. The window may be constructed in any manner which ensures a smooth and thin surface of optical quality. This may be accomplished through careful design of injection molding, machining, or by affixing thin film to a structural component which may be done by any of several methods known to those of ordinary skill in the art such as adhesive, thermal bonding, or ultrasonic welding.

In some embodiments, a second cavity bounding component, is fabricated, at least in part, from a solid flexible material such as silicone, fluorosilicone, vulcanized rubber such as ethylene propylene diene monomer (EPDM) rubber or associated derivatives/mixtures (e.g. Santoprene), other fluoroelastomer polymers (e.g. FKM, Viton) or other thermoplastic elastomer, which might be styrenic (i.e. a TPS such as styrene block copolymers like Styrolux), polyolefin based (e.g. cyclic olefin copolymer TPE), or copolyester-based (TPC), that can deform in response to pressure. The cavity bounding components can incorporate one or more regions designed as self-sealing injectable ports for introducing and allowing the exit of tissue processing fluids and, optionally, long-term tissue fluids, the latter of which may be fluids designed to solidify on cooling, exposure to secondary chemicals, or polymerization based on light exposure. The flexible material may be structural on its own or rendered more structural by being adhered to a stiffer material by any of means known to those of ordinary skill in the art such as adhesives, thermal welding, or overmolding. In some embodiments, the flexible material component incorporates an external open cavity designed to enable the placement of a (third) solid component which can compress the flexible material against a wall of the first internal cavity-forming component such as to add strength of a pressed seal which enhances the air-tight quality of the internal cavity.

In other embodiments, the second cavity bounding component is fabricated from a solid plastic material with a series of specific characteristics: low manufacture cost, sufficient flexibility to be able to form an air-tight seal with the first cavity-forming component, long-term resistance to the various tissue processing reagents including acidified methanol and organic solvents such as the combination of benzyl alcohol/benzyl benzoate, and, optionally, directly printable (for creating indelible identification marks). The plastic should also not interact with the fluorescent dyes involved in the processing such as Hoechst dyes, DAPI, eosin, rhodamines (e.g. rhodamine-6G, rhodamine 123, etc), sulforhodamines, acridine orange, thiazole orange, TO-PRO, SYTOX® (e.g. SYTOX Green), ALEXA® dyes (e.g. Alexa 647-NHS ester, Alexa 594-NHS ester, and chemical equivalents), and others. A plastic with this unique set of properties is polypropylene. A higher cost alternative is acetal copolymer or homopolymer, alternatively known by the trade name Delrin®. In some embodiments this second component includes one or more ports composed of flexible self-sealing material such as any of the elastomeric materials listed above. In other embodiments, the ports are self-closing by any of a range of other self-closing mechanisms known commonly to those skilled in the art such as spring-loaded ball valves or flexible port valves.

The tissue holder can also include one or more locating members, preferably outside the chamber containing the tissue, such as a post configured to fit within a corresponding recess in various processing apparatuses to thereby locate the tissue chamber relative to fluid inlets/outlets, imaging objectives, embedding removal tools, or other items. In various embodiments, the locating member may be on the processing apparatus and the tissue chamber may comprise a corresponding recess to receive the member.

In some embodiments, for the sake of ease of use, the tissue container may have overall external dimensions that are approximately that of a common microscope slide with added thickness to accommodate roughly cut, as opposed to thinly (10 um or less) sliced, specimens, or approximately 75 mm×25 mm×5 mm. In some preferred embodiments, also for ease of use and with the aim of minimizing manufacturing, materials, and storage costs, the tissue container has overall external dimensions that are approximately that of a common standard tissue cassette, typically about 40 mm×30 mm×6 mm and ranging from about 24-40 mm×24-30 mm×4-7 mm. The external dimensions of the container are also designed to accommodate internal cavity dimensions into which the majority of sample sizes which are commonly employed in standard histologic analysis can be adequately fit and processed, reducing changes to common practice and promoting adoption of the novel microscopy techniques.

Aspects of the invention include a container for holding a tissue sample with the container comprising a cavity or trough for receiving a tissue sample and a wall having an interior surface adjacent to the cavity and an exterior surface. In some embodiments, the chamber is loaded from the imaging side and an optically transparent imaging cover or sheet is affixed after tissue loading in such a manner that the tissue is not easily moveable in any direction while rendering the chamber substantially sealed to liquid and air. In other embodiments, the tissue is loaded directly onto the imaging window portion of a first component which forms the bounds (one surface and sidewalls) of a cavity to which a second component is used to effectively enclose the sample in a sealed cavity with the sidewalls of the first and second components forming an air-tight seal. Alternatively, the tissue can be loaded first into a cavity on the surface opposite the imaging surface and adjacent to the underside of the imaging surface. In either process, the tissue is loaded onto a surface, optionally in a specific oriented configuration, and then the members are brought together to form an internal closed cavity and render the tissue fully contained and manually inaccessible within the chamber and to substantially seal the chamber to liquid or air. In some embodiments, one component includes an optical window with the window comprising a plurality of features on the interior surface configured to contact the tissue sample and permit fluid flow between the tissue sample and the window. In some embodiments the surface opposite the optical window is also optically transparent or transmissive of specific wavelengths and may be used as an imaging window. The transmissive wavelengths may be those corresponding to precisely half the wavelength (twice the frequency) of the excitation laser wavelength, as would be generated by second harmonics (second harmonic generation).

In some embodiments, the elements of bounding the cavity are brought together in two separate steps. In the first step, the imaging window portion and the sealing base component are brought together such that they form a seal with a specific cavity depth that is larger than the thickness of the sample being processed, say 2, 3, 4, or 5 mm. Then tissue dyeing and dehydration takes place. The cassette may be oriented during processing so that the tissue is held by gravity against the surface opposite the imaging surface. This allows the dyeing fluid to reach the tissue surface that will be closest to the imaging window. Note that this may be accomplished in such a manner that the inlet port remains lower than an outlet port so that complete filling may occur without large air pockets being formed. It should be noted that the outlet port positioning refers to the path the fluid takes relative to a chamber and that this may be a different location than that of the outlet connection port. For example, a chamber may have an outlet channel that extends from a large cavity to another portion of the cassette, with channel dimensions such that capillary action allows effectively drawing outlet fluid or gas from a specific part of the chamber while making the positioning of the connector convenient for easy insertion into a processing machine. The initial relative position of the two chamber-forming components may be achieved reliably by having a feature that provides some resistance to manual compression such as by incorporation of a ridge, bump, or overhang that interferes with further compression of the two components, but is surmountable with additional manual pressure. This second step of bringing the imaging surface and the base of the sealing component closer together may take place either before or after the clearing step. Generally, the replacement of dehydrant with clearing fluid will progress faster if the additional compression of the chamber occurs after the specimen is incubated for some time with the clearing fluid, given the higher surface area available for diffusion exchange. However, from a practical point of view it can be preferable to compress the specimen at the moment the specimen is filled with clearing fluid so as to minimize the amount of time that the specimen needs to spend in a processing slot within a processor, allowing for improvements in overall throughput of a given device.

As noted above, the optical window can include a refractive index approximately equal to a refractive index of a fluid in which the tissue sample is immersed prior to imaging (e.g., a clearing solution). The refractive index of the clearing solution or other fluid to be used in processing the tissue sample may be approximately equal to the refractive index of a structure of the tissue sample to be analyzed. The optical window can comprise a refractive index of about 1.5 to about 1.7.

The size of the chamber may be any size which accommodates a tissue sample for microscopic analysis but in preferred embodiments is bounded by presently familiar sizes of tissues and existing tissue cassettes. Common samples which are manually (roughly) cut to be processed may have thicknesses that range from less than 0.5 mm up to 4 mm in thickness and other dimensions which may reach beyond 30 mm in length. A feature of particular value for the specific aspects of the invention herein described is that the internal cavity size and dimensions can be determined by varying only the second cavity-forming component. That is, in order to simplify the use and manufacture of components which accommodate differently sized tissues, the element with the windowed imaging surface can remain the same and the second element may be configured to form a seal against that first element while forming variable internal geometries that can help achieve the following: 1. orient long thin elements in a restricted long, thin orientation to improve imaging, 2. reduce the volume of expensive dye reagents for smaller specimens by filling portions of the chamber with solid material, and 3. still enable use of the same imaging window component for larger and/or thicker specimens. In addition, this second element can incorporate self-sealing injectable ports with positions that are constant for the various internal cavity geometries such that the closed specimen container can be utilized with a single type of processing instrumentation containing the needles and the fluids to be injected and exchanged.

In various embodiments the external planar dimensions of the chamber are those of a common tissue cassette, generally approximately 40 mm×30 mm×6 mm. The imaging portion of the chamber may be substantially smaller in some embodiments. For example, the imaging portion of a chamber for needle core biopsies may be between about 1.5 mm×15 mm and about 3 mm×40 mm, thereby fitting in a chamber with the external dimensions of a standard tissue cassette. In some embodiments the planar dimensions may be larger so as to accommodate specific specimen types having dimensions larger than the above-referenced core biopsies. For example, for imaging of an eye enucleation specimen, the chamber may have dimensions of between about 25 mm×25 mm and about 30 mm×40 mm. In other embodiments, the imaging chamber dimensions can be large enough to accommodate specimens typically referred to as large format histology specimens, or “whole mounts”, which are in the range of about 65 mm×50 mm in planar dimension. Similarly, the imaging chamber height may be any height required for accommodating a specific specimen type. For example, heights may be anywhere between about 200 μm and about 15 mm. In some embodiments, the imaging chamber may be between about 200 μm and 500 μm in height, best suited for cytology specimens and very small biopsies. In other embodiments the chamber height may be between about 500 μm and 1.5 mm, typically best suited for small and core biopsies. In other embodiments, the chamber height may be between 1 and 2 mm, best suited for samples cut thinly by hand.

Incorporation of a sponge support as discussed above may require a taller chamber height to accommodate both the sponge and the specimen. For example a chamber incorporating a sponge support may have a height of between about 1 mm and about 3 mm for small and core biopsies. In other embodiments, the chamber height can be between about 3 mm and about 6 mm, which may be best suited for regular tissue sections. In still other embodiments, the chamber height can be between about 6 mm and 15 mm, dimensions which may accommodate large format histology specimens as well general intermediate to large un-sectioned samples.

The external dimensions of a container comprising the chamber can vary depending on the dimensions of the enclosed tissue chamber and will be large enough to allow for any required fluid channels or external port plugs as described herein. In some embodiments the external dimensions of the container may include a height between about 1 mm and 10 mm. In other embodiments the container height can be between about 10 mm and 20 mm.

The plurality of features may comprise a material having a refractive index approximately equal to a refractive index of a fluid in which the tissue sample is immersed prior to imaging (e.g., a clearing solution). In certain embodiments, the refractive index of the clearing solution or other fluid to be used in processing the tissue sample may be approximately equal to the refractive index of a structure of the tissue sample to be analyzed.

The plurality of features can comprise a material having a refractive index of about 1.5 to about 1.7. The plurality of features may comprise a material having a refractive index of between about 1.51 and about 1.57. The plurality of features can comprise a material that dissolves in the presence of an organic solvent. The organic solvent may be a clearing solution such as benzyl alcohol and benzyl benzoate (BABB).

In various embodiments, the container may comprise a porous compressible material configured to contact the tissue sample on a side opposite the optically clear window. In some embodiments the porous compressible material is a plastic sponge. The sponge cell size may be any size that enables adequate tissue support with minimal compression and may be anywhere in the range of 10 μm to 5 mm. The sponge cell size may be in a range that helps wet both the tissue and optical surfaces without air bubble trapping. In preferred embodiments, the sponge cell size is between 50 and 500 μm when dry. In other preferred embodiments the sponge cell size is between 50 and 200 μm. The sponge may be open cell or closed cell. In preferred embodiments the sponge is open cell. In preferred embodiments the sponge is substantially non-fluorescent. In some embodiments the sponge is fabricated from a material that has a refractive index between about 1.45 and about 1.7. In some embodiments the sponge has a refractive index of between about 1.50 and 1.57. The sponge material may be selected to approximately match the refractive index of the cleared tissue sample to be imaged.

The container may comprise one or more fluid ports in fluid communication with the cavity for receiving the tissue sample and a space outside the chamber. In certain embodiments the chamber contains two ports. In other preferred embodiments the chamber contains three ports. The use of separate ports for injection of dehydration/dyeing fluid and for clearing fluid (e.g. BABB) plus a third for fluid exit/drainage, has the advantage of eliminating the risk of contamination of dehydrating/dyeing agent with clearing fluid. This may be of particular importance during processing as we have found that small amounts of clearing fluid interferes with adequate dyeing of samples. As such, preservation of reagent purity through port separation is a useful strategy. The two or three connection ports may be on the same cassette surface, facilitating connection to a fluid exchange system or processor. In preferred embodiments the fluid ports are self-sealing, such as with a rubberized or silicone plug or surface that permits introduction of a needle but which seals upon needle removal. In some embodiments the self-sealing ports are needle-free connectors, such as those that include a self-closing valve that opens when a tube connector is attached.

The container can comprise a material that is resistant and inert to acid, a material that is resistant to organic solvents such as BABB, a material that is resistant to alcohols and/or a material that is resistant to temperatures up to about 75 degrees Celsius. The sponge can comprise a material that is resistant to acid, a material that is resistant to organic solvents such as BABB, a material that is resistant to alcohols and/or a material that is resistant to temperatures up to about 75 degrees Celsius.

Aspects of the invention may include a method for analyzing a tissue sample including steps of orienting a tissue sample in a tissue chamber in a desired position; exposing the tissue sample to a first solution for chemical processing in the desired position in the tissue chamber; exposing the tissue to a fluid in which the tissue sample is immersed prior to imaging (e.g., a clearing solution) in the desired position in the tissue chamber; imaging the tissue sample in the desired position in the tissue chamber; optionally solidly embedding the tissue sample in the desired position in the tissue chamber.

The clearing agent may be BABB. The first solution may comprise a dehydrant, a fixative, a dye, and/or some combination thereof including where the fixative may be a dehydrant. In certain embodiments, the dye may be a fluorescent dye and the imaging step can comprise fluorescent imaging. The desired position may be a desired position for sectioning of the wax-embedded tissue sample and or imaging of the tissue sample. The tissue chamber can comprise a plurality of features disposed on an interior surface of the tissue chamber and configured to contact the tissue sample and permit fluid flow between the tissue sample and the interior surface.

### BRIEF DESCRIPTION OF THE DRAWINGS

FIG. 1 shows a tissue chamber having a trough and fluid inlets and outlets.

FIG. 2 shows a top view of a tissue chamber.

FIG. 3 shows a cutaway view of a tissue chamber with locating members.

FIG. 4 shows a tissue chamber having a plurality of features for spacing a sample away from the chamber wall.

FIG. 5 illustrates a container 1001 including a support sponge 1013 according to certain embodiments.

FIG. 6 illustrates some of the internal configuration of the container 1001 shown in FIG. 5.

### DETAILED DESCRIPTION

The present invention provides apparatuses, systems, and methods for the visual histologic analysis of tissue during chemical processing (e.g., fixing, dehydrating, dyeing, and clearing) and, optionally, embedding while reducing manual intervention, human contact, and labor costs during processing. Systems and methods allow for initial placement of a tissue sample in a single container in a preferred orientation for embedding and/or imaging prior to embedding. The tissue sample can then be chemically processed (optionally fixed, dehydrated, dyed, and cleared) and optionally embedded in paraffin or other medium in the single container without subsequent direct manual repositioning of the sample. Furthermore, the tissue sample can be dyed, cleared and imaged intact to provide an initial pathological analysis potentially negating the need for continued expensive and labor intensive processing, embedding, sectioning, staining, and analysis. Systems and methods of the invention allow for positioning of the sample in a particular orientation for automated processing to reduce the likelihood of gas bubble interference.

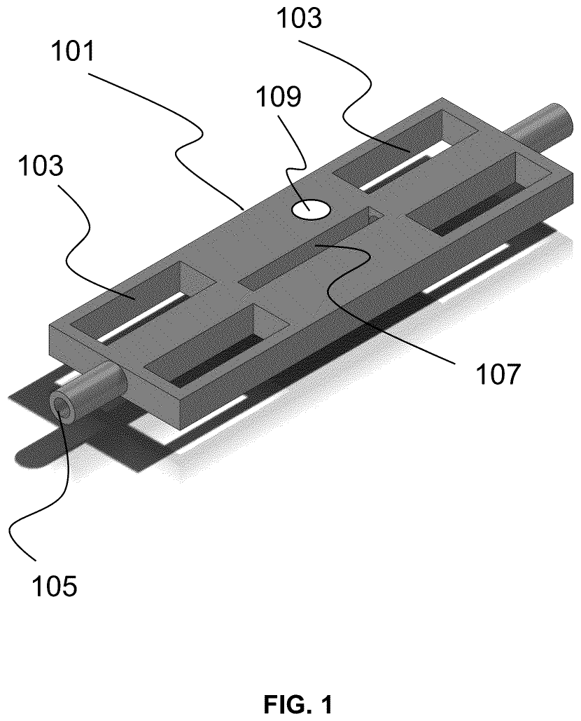

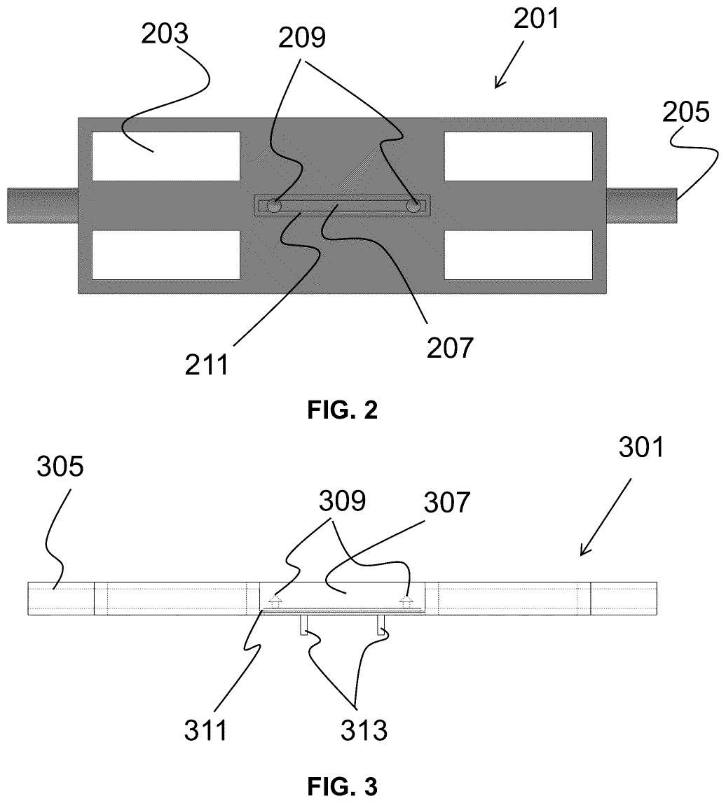

FIG. 1 shows a tissue cassette 101 having a trough 107 for receiving and processing a tissue sample. Samples may be obtained, for example, during surgery, biopsy, fine needle aspiration, culture, or autopsy and are preferably obtained for histological analysis. Tissue cassettes 101 and/or troughs 107 therein may be provided in a variety of sizes and may include a mark 109 (human and/or machine-readable) that can correspond to the trough 107 or chamber 101 size and/or provide information regarding the subject from which the sample was obtained, the type of sample, and/or the type of analysis to be performed. Once read by a machine or human, the mark 109 may be used to tailor tissue processing (e.g., reagent selection, reagent volumes, or processing apparatus selection and configuration) and/or to label imaging data. Additional information derived from a laboratory or hospital information system may be used to further tailor the specifics of tissue processing protocols.

Tissue cassettes 101 may include a remainder area surrounding the trough 107 to increase the overall size and allow for ease of manipulation. This remainder area may incorporate channels for directing the fluid between specific locations relative to a chamber cavity and connecting ports. Cutaways 103 or openings in the cassette 101 can reduce the mass of the cassette 101 along with reducing the required material in production, time of production, and the associated costs thereof. One or more fluid inlets/outlets 105 are in fluid communication with a chamber (created by the trough 107 and a portion of the cassette) and an outside surface of the cassette 101. The fluid inlets/outlets 107 can interface with the corresponding fluid inlets/outlets in various processing apparatuses to provide and remove processing fluids such as fixatives, dehydrating fluids, stains/dyes, clearing solution, or wax for embedding. Features such as rails, grooves, or recesses may be incorporated into the external aspects of the cassettes to enable accurate positioning relative the viewing window.

The walls of the tissue chamber or relevant portions thereof (e.g., an imaging window) may be optically clear and/or index matched to the clearing solution and/or the sample structures to be measured. The tissue cassette 101 is thereby operable to contain a tissue sample for all processing steps for histological analysis while allowing for periodic imaging of, for example, an intact and wax-free sample including fluorescent dye-based imaging techniques. After fixing, dyeing, dehydrating, and/or any other processing steps are performed, embedding medium such as paraffin, other wax, or polymer can be introduced to the chamber formed by the trough 107 and cassette 101 via the fluid inlets/outlets 105 to provide a wax-embedded sample in a block of wax ready for sectioning and subsequent analysis.

Accordingly, a tissue sample can be initially oriented within the trough 107 or on the imaging portion of the cassette 101 in the desired position for both initial imaging and later sectioning and then left untouched throughout the remainder of the processing, imaging, and embedding steps.

Tissue chambers may be constructed of materials such as metals, plastics, a cyclic olefin copolymer, a styrene butadiene copolymer, or glass. Preferably the chamber material does not react with the tissue sample or any of the processing solutions with which its surfaces come in contact. Chambers can be constructed of multiple materials in certain embodiments. For example, the imaging window of the cassette may be constructed of an unreactive and index matched material but, to reduce costs, the remainder of the cassette may be constructed of a different, cheaper material.

FIG. 3 shows a cutaway view of a tissue chamber 301 with fluid inlets/outlets 305 shown providing fluid access to the trough 307 from the outside surface of the chamber 301. The bottom surface of the trough 307 can comprise locating members 313 such as posts or tabs (or corresponding recesses for receiving such members). The locating members 313 may correspond to complimentary locating recesses on the surface of various processing and imaging apparatuses. It will be readily apparent that while described herein with respect to the members being present on the chamber 301 and the corresponding recesses being present on the apparatuses, the reverse arrangement would also provide the same function. The locating members 313, when positioned in their corresponding recesses, may serve to locate the chamber 301 and the trough 307 within the apparatuses relative to, for example, a fluid coupling for the fluid inlets/outlets 305, a wax-cutting blade, a plunger for separating the trough 307 floor along the frangible area 311, an imaging objective, a light source, or various other processing tools.

Tissue chambers may be reusable or single-use items.

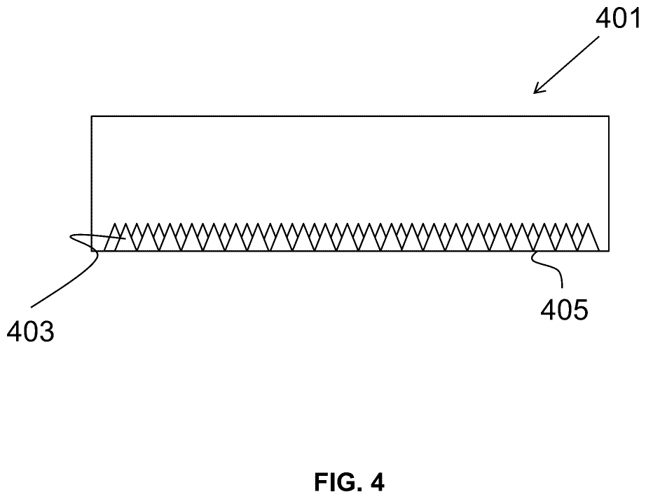

FIG. 4 shows a tissue chamber 401 having a plurality of features 403 for spacing a sample away from the chamber wall 405. Spacing the sample away from the otherwise flat surface of the chamber wall 405 allows for processing solutions such as dehydrating, fixing, clearing, and dye solutions, to access all sides of the sample. In the absence of such features 403 the sample would rest against the flat surface of the chamber wall 405 sealing it off from the fluids and increasing processing times, reducing processing effectiveness (and subsequent analysis quality), and/or requiring manipulation or agitation to re-orient the sample and expose the obstructed surfaces to the fluids. Features may be of any shape including cones, pyramids, needles, cylinders, spheres, cubes, ridges, spikes, or other 3-dimensional shapes. Features may include porous structures or recesses in a material surface to allow fluid penetration or access. Features 403 should be shaped and spaced such that they provide the minimal contact surface area with the sample while still supporting the sample above the surface of the wall 405 and enough weight distribution so as not to puncture or otherwise penetrate the sample.

The features should have a height or depth sufficient to allow fluid to flow between the supported sample and the surface of the chamber wall. In various embodiments, features may have a height or depth about 1 μm to about 5 mm. In preferred embodiments the features have a height or depth of about 100 μm to about 500 μm.

An apparent drawback to such features 403 would be their deleterious effects on imaging quality. Accordingly, in various embodiments the features may be constructed of a material similar or identical to the wall 405 of the chamber 401 and be index matched to the clearing solution and/or the sample structures to be examined. As the imaging window is also fabricated from a material that is index matched to the clearing solution, the features may be etched or otherwise molded into the imaging window itself. The features 403 will thereby provide minimal distortion during imaging. In other embodiments, the features 403 may be constructed of a material different from the walls 405 of the chamber 401 and that material may be configured to dissolve in the presence of one or more of the processing solutions (e.g., the clearing solutions). The material ideally has a combination of features that make it most suitable for accomplishing the goals of adequate fluid exposure during dehydration and dyeing while not impairing imaging by dissolving in a clearing solution. Given this, ideal materials are sufficiently resistant to alcohols such as methanol, and acidified alcohols, such as methanol with acetic acid, so as to remain essentially unaffected for the period of dehydration incubation (ranging from minutes to 12 or more hours), but dissolve quickly (seconds to minutes) upon exposure to an organic solvent such as benzyl alcohol or benzyl benzoate or a mixture of the two. An example of such a material is polyvinyl chloride. Another preferred example of such a material is methyl methacrylate butadiene styrene copolymer (MBS), such as that sold under the name Zylar 670. This latter material has the added advantage that it has a refractive index that is closely matched with that of the clearing fluid known as BABB (benzyl alcohol/benzyl benzoate), since that means that upon dissolution it does not markedly perturb the optical properties of the dissolving fluid and can maintain ideal imaging conditions even with some residual material remaining in the imaging path. Because the clearing solution is generally applied before imaging, if the features 403 dissolve in the presence of the clearing solution, they will not be present to distort the subsequent imaging. Clearing solutions may comprise benzyl alcohol and benzyl benzoate (BABB) and, accordingly, features 403 may comprise materials known to dissolve in BABB. In ideal embodiments, the material that quickly dissolves in BABB is also chemically resistant to acidified methanol. In further preferred embodiments, the material quickly dissolves in BABB, is resistant to acidified methanol, and does not react with typical general protein and nuclear fluorescent dyes. As described, the role of this material is to be a dissolvable spacer between the tissue and the imaging window. This spacer can be configured in many shapes to accomplish the spacing goal. One such configuration is as a sheet with multiple holes, gaps, or strips devoid of material. If the sheet incorporates strips of removed material, the strips effectively act as channels that allow fluid exchange to a large portion of a specimen surface that would otherwise be isolated from fluid access due to its proximity to the eventual imaging window, while providing sufficient rigidity to the sheet to prevent complete deformation.

In certain embodiments, the bottom surface of the chamber may include features for receiving or positioning certain tissue sample shapes or types. For example, a v-shaped or half-cylinder notch may be formed in the bottom surface for accepting and positioning a long, narrow sample such as a core biopsy sample. Such an embodiment is depicted in FIG. 13 with a core biopsy sample resting in a notch on the bottom surface of the chamber. Such features can allow for fluid exchange on all sides while restricting the tissue sample's orientation to a fairly straight line which is beneficial for fast imaging by reducing the number of imaging scans required to capture the entire specimen.

Processing devices of the invention may include a receptacle for the cassette which orients it in such a fashion that the inlet port is at or near the lowest position and the outlet port is at or near the highest position relative to the ground. In this manner introducing fluid through an inlet port ensures air or gas can escape first through the outlet port, reducing the likelihood of bubble being trapped adjacent to the tissue which would have the effect of slowing fluid exchange or dyeing. As bubbles may form during the incubation periods of processing, the processing device may also incorporate a mechanism for periodically or continuously withdrawing fluid and refilling fluid. Given the orientation and geometry of the fluid ports, this will result in effective mixing of fluids, increasing the concentration gradients at the tissue surface which improves diffusion exchange, and will also aide in the dispersion and exhaust of gas bubbles.

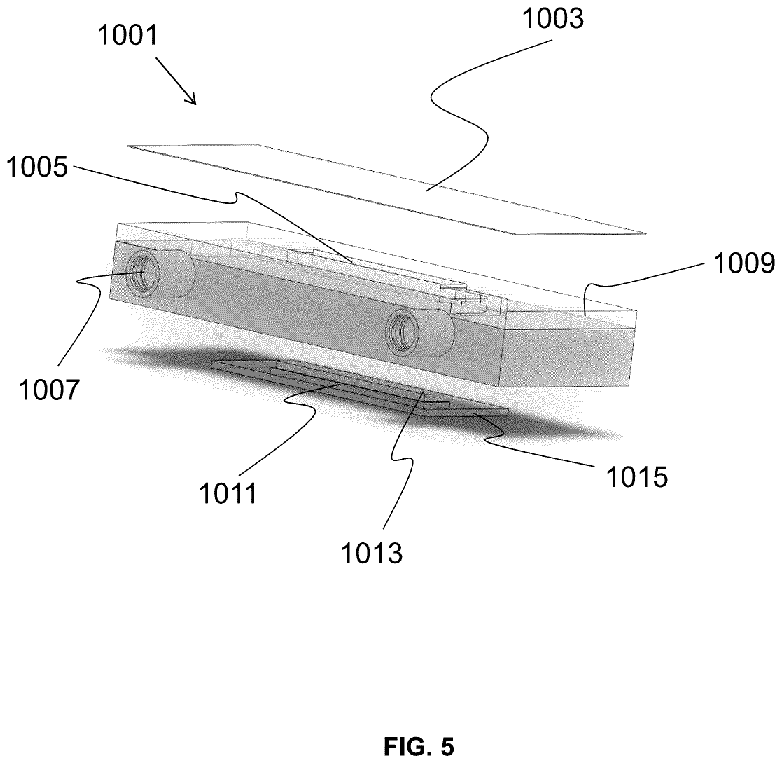

FIG. 5 illustrates a container 1001 including a support sponge 1013 according to certain embodiments. The container 1001 includes a specimen chamber 1005 to receive a tissue sample as well as two fluid ports 1007 to introduce and remove fluid from the specimen chamber 1005. The container 1001 includes a cover 1003 that encloses the specimen chamber 1005 after a tissue sample has been placed therein. The fluid ports 1007 may be sealable or self-sealing, especially where the cover 1003 is operable to form a fluid and air-tight seal with the top of the container 1001 to create a sealed environment within the specimen chamber 1005. As noted above, self-sealing fluid ports 1007 may include a rubberized or silicone plug or surface that permits introduction of a needle but which seals upon needle removal. In some embodiments the self-sealing ports are needle-free connectors, such as those that include a self-closing valve that opens when a tube connector is attached. In other embodiments the ports are sealable such as by heating or by introduction of an external device such as a plug. The container 1001 may include a bottom cover 1015 with a sponge support 1013 or other support as discussed herein. The sponge support 1013 and/or the bottom cover 1015 may form the bottom of the specimen chamber 1005 and may comprise an optically transmissive, transparent, or index-matched material (e.g., having approximately the same refractive index as the cleared tissue sample to be imaged) such as an optically transmissive window 1011 in the bottom cover 1015.

A sponge or other porous compressible material is configured to contact the tissue sample and hold the tissue sample in place after positioning within a tissue chamber for chemical processing, clearing, and/or imaging. In some embodiments the porous compressible material is a plastic sponge. The sponge cell size may be any size that enables adequate tissue support with minimal compression and may be anywhere in the range of 10 μm to 5 mm. The sponge cell size may be in a range that helps wet both the tissue and optical surfaces without air bubble trapping. In preferred embodiments, the sponge cell size is between 50 and 500 μm when dry. In other preferred embodiments the sponge cell size is between 50 and 200 μm. The sponge may be open cell or closed cell. In preferred embodiments the sponge is open cell. In preferred embodiments the sponge is substantially non-fluorescent. In some embodiments the sponge is fabricated from a material that has a refractive index between about 1.45 and about 1.7. In some embodiments the sponge has a refractive index of between about 1.50 and 1.57. The sponge material may be selected to approximately match the refractive index of the cleared tissue sample to be imaged. The sponge can comprise a material that is resistant to acid, a material that is resistant to organic solvents such as BABB, a material that is resistant to alcohols and/or a material that is resistant to temperatures up to about 75 degrees Celsius.

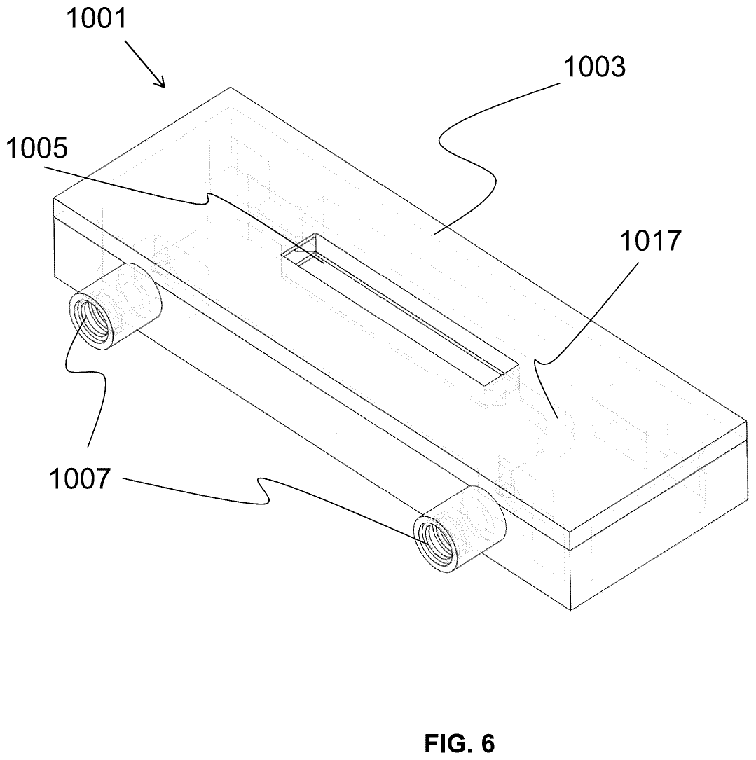

FIG. 6 illustrates some of the internal configuration of the container 1001 shown in FIG. 10 including the internal fluid passages 1017 leading from the fluid ports 1007 to the specimen chamber 1005. The fluid ports 1007 is optionally positioned at a planar level offset from the level of the specimen chamber 1005, such that they can be oriented higher than the specimen chamber 1005 during fluid exchange. Due to the lower density of air and other gases relative to processing fluids, such orientation aids in the removal of gas from the specimen chamber 1005 during fluid exchange, ensuring optimal surface contact for dyes and processing chemicals and preventing imaging distortion due to trapped gas.

In certain embodiments a chamber may be large enough that careful avoidance of air introduction and capillary action with the chamber walls may not sufficiently prevent gas bubble formation. Accordingly, not only can inlets/outlets and/or fluid ports can be positioned on the specimen chamber to allow air purging, but, in certain embodiments, fluid filling and exchange can be performed with the chamber itself oriented such that the fluid ports are elevated to allow gas to escape. For example, for a fluid chamber with cross-sectional dimensions perpendicular to the fluid flow direction that is at least 2.5 mm in at least one dimension, keeping a chamber flat on a surface during loading of an aqueous or alcohol-based solution (with the imaging surface parallel to the floor) can result in a high likelihood that gas will not be all able to escape the chamber prior to fluid reaching the outlet. The attractive forces between the fluid and the surfaces influence the specific dimensions for which this risk is high. Accordingly, the dimensions for which capillary forces prevent bubble formation during fluid loading in a horizontal configuration may be dependent on the specifics of the fluid and the surrounding solid material.

In some embodiments, therefore, the chamber may be oriented vertically during filling, so that the outlet at or near the highest point of the interior chamber when filling and, in certain preferred embodiments, higher than the inlet port, allowing gas to fully escape prior to the chamber being filled. The chamber can be filled in vertical orientation. As fluid enters the chamber the gas is displaced and exits out of the elevated outlet port at the top of the chamber. Using a slow fill speed, less than approximately 200 uL/s, and preferably less than 100 uL/s, for chamber cross-sectional area of approximately 4 mm², can also considerably reduce the risk of bubbles forming alongside the tissue or within the chamber. Larger cross-sectional areas can accommodate faster fill speeds given the lower likelihood of capillary action playing a significant role in trapping of gas. This may be especially true for the higher viscosity liquids such as those used for clearing (benzyl alcohol/benzyl benzoate) but can also be applied to low viscosity liquids such as alcohol-based reagents. In various embodiments, the outlet height may only be slightly higher than the inlet height, such as those designed to enable gravity to hold the specimen away from the imaging window portion during exposure to dyeing chemicals. A larger difference in heights lowers the risk of bubble formation further, but larger specimens are more likely to require imaging surface access during dyeing and are in larger cavities that are less prone to bubble trapping. Ideally, the outlet may be located at or near the highest point in the chamber when oriented for filling. Surface tension of fluid can still help ensure the air is fully expelled during filling. The position of the inlet port is less critical, as long as it is lower than the outlet, but the higher it is the more risk there is of air being trapped below the inlet level, so the lowest point for the inlet is preferred. In certain embodiments, the chamber may be inclined away from the full vertical position (perpendicular to floor) without markedly affecting the ability to fully expel air during filling and it can help reduce the difference between the highest point of the chamber and the outlet port. In practical terms, the angle of the chamber relative to a level surface during fluid filling may be between about 5 degrees and about 90 degrees. Optimally it may be between about 45 and about 90 degrees for small diameter chambers and about 15-30 degrees for large chambers with lower bubble trapping risk. Such an orientation can also eliminate the need to fully eliminate gas bubbles from the inlet tubing. With slow injection, such bubbles, even if entering the chamber, will rise more quickly than the fluid level, and thereby exit the chamber quickly, maintaining a gas-free environment surrounding the tissue during processing and subsequent imaging. As discussed above, inlet and outlet ports may be valved or otherwise sealable which allows the chamber to be air-free or substantially air-free after the clearing step, meaning the chamber can be re-oriented into the horizontal position for imaging after the inlet and outlet connectors are removed.

In this vertical configuration, a technique which we have determined to further reduce the persistence of gas bubbles is to periodically or continuously withdraw fluid from the chamber and refill the chamber. The withdrawal of fluid does not necessarily need to be complete—fluid may remain in the chamber during fluid withdrawal. The fluid movement produces shear forces that help separate bubbles adjacent to tissue or chamber walls. Due to the lower density, the bubbles may rise, counter to the fluid movement. But also they can be dislodged and expelled from the chamber during the subsequent re-filling action. Thus, the geometry and orientation of the chamber can be coupled with fluid movement to minimize the undesirable effects of bubbles.

In certain embodiments, a two-part or three-part chamber may be used. One part may be made of a refractive index-matched plastic and incorporate an imaging window of a specified thickness. In some embodiments, an image window thickness of about 500 μm may maximize access to deep imaging while providing sufficient structural integrity to reduce risk of breakage while also allowing for injection molding construction. In other embodiments, a thinner window of between 100 and 200 μm is preferred, as it can reduce the aberrating effect of imperfect matching of the refractive index. In preferred embodiments, the window is 100 μm or less, minimizing the aberrating effects any refractive index mismatch might have. Surrounding plastic around the imaging window can provide further structural integrity against bending and other distortions while facilitating human manipulation. The first part with the imaging window can include a cavity sized and shaped to receive the second part to form a sealed chamber. The second part can be constructed entirely of silicone or similar flexible material such as thermoplastic elastomer or vulcanized rubber compound to facilitate sealing or, in certain embodiments, at least one of the first and second parts may incorporate a flange, gasket or other portion made of such a material to facilitate sealing.

In certain embodiments, a flexible portion such as a part made of or featuring silicone or rubber, may be thin enough to allow the part to flex. If such a portion forms a wall of the chamber or a portion thereof, flexibility therein can allow for the chamber to accommodate variations in tissue thickness. In various embodiments the flexible portion may be a wall opposite the imaging window and can apply resistance to compress the tissue against an imaging window. Such flexibility can also provide processing advantages by optionally expanding during fluid filling to expose tissue areas that may otherwise become inaccessible to fluid, such as a region against the imaging window of part 1 and/or, upon removal of excess fluid, be pulled inward to compress the sample against the window for imaging. Accordingly, pressure differentials between fluid within the chamber and the external pressure (e.g., ambient pressure) can be manipulated to achieve the desired effect. Such negative pressure to cause compression of the sample may be achieved, for example, by the BABB fluid being pulled by gravity down an outlet tube (a siphoning effect), or by actively drawing out the fluid, or by increasing the external pressure on the chamber.

In certain embodiments, the flexible component incorporates an external cavity which serves as a receptacle for a third solid component designed to strengthen the air-tight seal of the cavity and potentially also as a medium for affixing identifying information such as a label or for directly printing such information. The sealing effect of this solid component is provided by creating pressure radially against the flexible component in opposition of the pressure being produced radially inward against the peripheral walls of the flexible component. The radial direction of the compression by the imaging window containing component and that of the external third solid component may be reversed so that the flexible component forms the lower wall of a cavity by surrounding the cavity wall formed by the upper (imaging window) component and the third solid component forms an outer ring around the flexible component, eliciting the same counter-compressive effect. Additionally, this third solid component may be designed with perforations which facilitate movement of the flexible aspect of the cavity wall but reducing the buildup of pressure between the outer wall of the flexible aspect of the cavity and this sealing component.

Despite silicone being reported as incompatible with benzyl alcohol and benzyl benzoate, systems and methods of the invention recognize that silicone absorption of BABB is slow and does not impede use of the material in the techniques described herein. Similar behavior applies to other thermoplastic elastomers, such as those derived from vulcanizates (TPVs). Furthermore, silicone and TPVs do not appreciably lose structural integrity on exposure to any of the chemicals used in the processing methods described herein for periods of at least 1 year. In certain embodiments, fluorosilicone may be used to further reduce adverse reactions with the chemicals used in processing. As mentioned, in other preferred embodiments, vulcanized rubber or ethylene propylene diene monomer (EPDM) rubber or compounds derived from mixing EPDM and polypropylene can be used instead of silicone providing a low cost alternative with prolonged resistance to organic solvents.

Methods of the invention may include single-chamber chemical processing, imaging, and embedding such that the tissue sample may be initially positioned within the chamber in a desired orientation for sectioning and/or imaging and left without further manipulation until the optional removal of the embedded sample for sectioning.

Chemical processing may include fixing, dehydrating, clearing, dyeing, and other steps known in the art and useful for both intact tissue imaging (e.g. fluorescent staining or fluorescent antibody staining, and imaging) and histological analysis (e.g., embedding and microtome sectioning). In certain embodiments, the tissue sample may be exposed to one or more stains, fixatives, dehydrants, and/or clearing agents within a single tissue chamber as described herein. In some embodiments the fixation occurs prior to positioning the sample in the cassette chamber. In some instances, one or more of the above stains, fixatives, dehydrants, and/or clearing agents may be combined in a single solution. Suitable examples of chemical processing solutions and techniques are described in U.S. Pub. 2016/0003716 and U.S. Pub. 20160003715, the contents of each of which are incorporated herein by reference.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A container for holding a tissue sample, the container comprising:
a first component made of a rigid material and comprising a cavity having an imaging window on one surface thereof; and
a second component at least in part made of a flexible material and sized and shaped to create an airtight sealed chamber when inserted into the cavity of the first part.

2. The container of claim 1, wherein the rigid material comprises an optical grade plastic.

3. The container of claim 1, wherein the imaging window is refractive-index matched to a refractive index of a fluid to be used in processing a tissue sample to be analyzed.

4. The container of claim 1, wherein the imaging window is refractive-index matched to a refractive index of a structure of a tissue sample to be analyzed.

5. The container of claim 1, wherein the flexible material comprises silicone.

6. The container of claim 1, wherein the flexible material comprises fluorosilicone.

7. The container of claim 1, wherein the flexible material comprises ethylene propylene diene monomer rubber (EPDM).

8. The container of claim 1, wherein the second component comprises a cavity for receiving a tissue sample.

9. The container of claim 1, wherein one or more of the first component and the second component comprises one or more fluid ports.

10. The container of claim 1, wherein the second component comprises a deformable portion operable to compress a tissue sample within the airtight sealed chamber against the imaging window upon application of a negative pressure differential to the airtight sealed chamber.

11. A container for processing a tissue sample, the container comprising:
an airtight chamber for holding a tissue sample to be processed;
a sealable inlet port providing fluidic access to the airtight chamber; and
a sealable outlet port providing fluidic access to the airtight chamber and located on the container such that, when the container is positioned for filling for tissue processing, the valved outlet port is at or near a highest point of the airtight chamber and higher than the valved inlet port.

12. The container of claim 10, further comprising a surface comprising a plurality of features configured to contact a tissue sample, reduce surface area contact between the tissue sample and the surface by spacing the tissue sample from the surface, and permit fluid flow between the tissue sample and the surface, the features comprising three-dimensional structures positioned on the surface.

13. The container of claim 11, wherein the plurality of features comprise a material having a refractive index approximately equal to a refractive index of a fluid to be used in processing the tissue sample.

14. The container of claim 12, wherein the refractive index of the fluid to be used in processing the tissue sample is approximately equal to a refractive index of a structure of the tissue sample to be analyzed.

14. The container of claim 13, wherein the plurality of features comprise a material having a refractive index of about 1.5 to about 1.7.

15. The container of claim 14, wherein the plurality of features comprise a material having a refractive index of between about 1.53 and about 1.60.

16. The container of claim 11, wherein the plurality of features comprise a material that dissolves in the presence of an organic solvent.

17. The container of claim 16, wherein the organic solvent is a clearing solution.

18. The container of claim 11, comprising a porous compressible material configured to contact the tissue sample on a side of the tissue sample opposite the surface.

19. The container of claim 18, wherein the porous compressible material has a refractive index that is approximately equal to a refractive index of the tissue sample to be analyzed.

20. The container of claim 11, wherein at least a portion of the surface comprises a refractive index approximately equal to a refractive index of a fluid to be used in processing the tissue sample.

21. The container of claim 20, wherein the refractive index of the fluid to be used in processing the tissue sample is approximately equal to the refractive index of a structure of the tissue sample to be analyzed.

22. The container of claim 20, wherein the at least a portion of the surface comprises a refractive index of about 1.5 to about 1.7.

28. The container of claim 11, wherein the surface at least partially defines a cavity for receiving the tissue sample.

29. A method for analyzing a tissue sample, the method comprising:
orienting a tissue sample in a tissue chamber in a desired position, the tissue chamber comprising:
a valved inlet port providing fluidic access to the tissue chamber; and
a valved outlet port providing fluidic access to the tissue chamber;
positioning the tissue chamber in a processing orientation such that the valved outlet port is positioned higher than the valved inlet port and at or near a highest point of the tissue chamber relative to ground;
exposing the tissue sample to a first solution for chemical processing in the desired position in the tissue chamber in the processing orientation by introducing the first solution through the valved inlet port and allowing air to escape the tissue chamber through the valved outlet port;
immersing the chemically processed tissue sample in a fluid in the desired position in the tissue chamber in the processing orientation by introducing the fluid through the valved inlet port; and
imaging the immersed tissue sample in the desired position in the tissue chamber without repositioning the tissue sample after orienting.

30. The method of claim 29, further comprising embedding the tissue sample in the desired position in the tissue chamber in the processing orientation by introducing embedding fluid through the valved inlet port.

31. The method of claim 30, wherein the desired position is a desired position for sectioning of the embedded tissue sample.

32. The method of claim 29, wherein the fluid comprises a clearing agent.

33. The method of claim 32, wherein the clearing agent is BABB.

34. The method of claim 29, wherein the first solution comprises a dehydrant.

35. The method of claim 29, wherein the first solution comprises a fixative.

36. The method of claim 35, wherein the fixative is a dehydrant.

37. The method of claim 29, wherein the first solution comprises a dye.

38. The method of claim 37, wherein the dye is a fluorescent dye and the imaging step comprises fluorescent imaging.

39. The method of claim 29, wherein the desired position is a desired position for imaging of the tissue sample.

40. The method of claim 29, wherein the tissue chamber comprises a plurality of features disposed on an interior surface of the tissue chamber and configured to contact the tissue sample and permit fluid flow between the tissue sample and the interior surface.

41. A container for holding a tissue sample, the container comprising a surface comprising a feature configured to receive and position a tissue sample in a desired position.

42. The container of claim 41, wherein the feature comprises a v-shaped notch and the tissue sample is a core biopsy sample.

43. The container of claim 3, wherein a thickness of the window is between about 100 and about 500 μm.

44. The container of claim 4, wherein the imaging window is refractive-index matched to a refractive index of about 1.515.
